(19) United States
(12) Patent Application Publication
(10) Pub. No.: US 2007/0104818 A1
(43) Pub. Date: May 10, 2007

(54) Machine for molding articles made of loose material, for manufacturing loading pallet stringers

(75) Inventor: Paolo Benedetti, Modena - Frazione San Damaso (IT)

Correspondence Address: MODIANO & ASSOCIATI, Via Meravigli, 16, Milan, 20123, IT

(73) Assignee: IMAL S.R.L.

(21) Appl. No.: 11/356,973

(22) Filed: Feb. 21, 2006

(30) Foreign Application Priority Data
Nov. 4, 2005 (IT) MO2005A000290

(51) Int. Cl. B29C 43/02

(52) U.S. Cl. 425/406

(57) ABSTRACT

A machine for molding articles made of loose material, particularly for manufacturing stringers for loading pallets, comprising an upper mold part and a lower mold part, which can be moved mutually closer and can be mutually superimposed with the interposition of at least one layer of loose material in order to mold at least one article. At least one element for shaping at least one portion of the article during molding which is further provided, associated detachably with at least one among the upper mold part, the lower mold part and the layer of loose material.

The present invention relates to a machine for molding articles made of loose material, particularly for manufacturing stringers for loading pallets.

### BACKGROUND OF THE INVENTION

It is known that loading pallets are implements which are generally made of wood and are widely employed to form transportable loading units of various goods, such as for example finished products, intermediate components, or the like.

Conventionally, each pallet is constituted by a loading platform, which is quadrangular and is constituted generally by a plurality of boards arranged so that they are mutually parallel and coplanar, and is supported by a footing which is variously shaped depending on the type of application of the pallet.

The footing can be constituted by supporting cross-members, commonly known as stringers, of which two are fixed at two mutually opposite sides of the platform and one is fixed at the centerline of such platform, the stringers being mutually parallel so as to delimit two seats which are adapted for the insertion of the forks of the lift trucks used to handle the pallets.

In the case of four-way pallets, each of the stringers is further provided with two recesses, which are adapted to form additional seats for the insertion of the forks of lift trucks, which are substantially transverse with respect to the above-mentioned seats and ensure the possibility to load the pallet from each one of its sides.

It is known to use machines adapted to produce stringers by pressing loose wood-based material (with the optional addition of binders).

These machines generally comprise a substantially elongated container provided with an upper opening. A pressing plate is arranged in an upper region with respect to the container and can perform a translational motion along a substantially vertical axis from an inactive position, in which the plate lies outside the container, to an active position, in which the plate is inserted within the container, through such opening.

The plate is shaped conventionally so as to form two mutually spaced protruding portions, which extend from the mold toward the container.

A preset amount of loose material, in the form of powder or chips, is moved toward the press. The plate moves downward and the pressing action on the material, together with the optional action of heating means (for example by introducing steam), allows to obtain a compact block which is molded so as to provide a stringer.

The particular shape of the container and of the press give the stringer the appropriate elongated shape, and the presence of the protrusions allows to form the substantially concave portions of the stringer.

These known machines are not free from drawbacks, including the fact that the pressing thus performed provides higher compression at the protruding portions of the plate, leading to a final product whose quality is not high as regards uneven density along its entire extension.

Moreover, if one wishes to manufacture stringers having different shapes and dimensions, it is necessary to replace the plate completely, with substantial machine setup times and with a consequent increase in general production costs.

### SUMMARY OF THE INVENTION

The aim of the present invention is to eliminate the above-mentioned drawbacks of the background art, by providing a machine for molding articles made of pressed loose material which allows to manufacture stringers for loading pallets, while ensuring high productivity and relatively high quality of the resulting stringers.

An object of the present invention is to allow the molding of stringers having a different shape while minimizing the corresponding setup times of the machine.

Another object of the present invention is to ensure a quick production cycle, with a consequent reduction of general production costs.

Within this aim, a further object of the present invention is to provide a structure which is simple, relatively easy to provide in practice, safe in use, effective in operation, and has a relatively low cost.

This aim and these and other objects that will become better apparent hereinafter are achieved by the present machine for molding articles made of loose material, particularly for manufacturing stringers for loading pallets, comprising an upper mold part and a lower mold part, which can be moved mutually closer and can be mutually superimposed with the interposition of at least one layer of loose material in order to mold at least one article, characterized in that it comprises at least one element for shaping at least one portion of the article during molding which is associated detachably with at least one among the upper mold part, the lower mold part and the layer of loose material.

### BRIEF DESCRIPTION OF THE DRAWINGS

Further characteristics and advantages of the present invention will become better apparent from the following detailed description of a preferred but not exclusive embodiment of a machine for molding articles made of loose material, particularly for manufacturing stringers for loading pallets, illustrated by way of non-limiting example in the accompanying drawings, wherein:

FIGS. 1 and 2 are schematic and sectional front views of a first embodiment of the machine according to the invention, in two different operating configurations;

FIG. 3 is a schematic and sectional front view of a second embodiment of the machine according to the invention;

FIG. 4 is a perspective view of a stringer for loading pallets, obtained by way of the machine according to the invention;

FIG. 5 is a perspective view of a loading pallet.

### DESCRIPTION OF THE PREFERRED EMBODIMENTS

With reference to the figures, the reference numeral 1 generally designates a machine for molding articles made of pressed loose material.

Specifically, the manufactured article 2 is constituted by a cross-member, shown in FIG. 4, which is employed for loading pallets 3 which are used generally in the field of the transport and handling of goods, and is conventionally termed stringer.

The machine 1 comprises an upper mold part 4 and a lower mold part 5, which can be moved mutually closer and mutually superimposed, with the interposition of loose material 6, in order to mold the stringer 2.

The loose material 6 can be a continuous stream of a substantially homogeneous material, which receives the addition of binders adapted to facilitate its setting during the step of molding by pressing, and is moved by way of a conventional feeder line 7, of the type of a conveyor belt or the like.

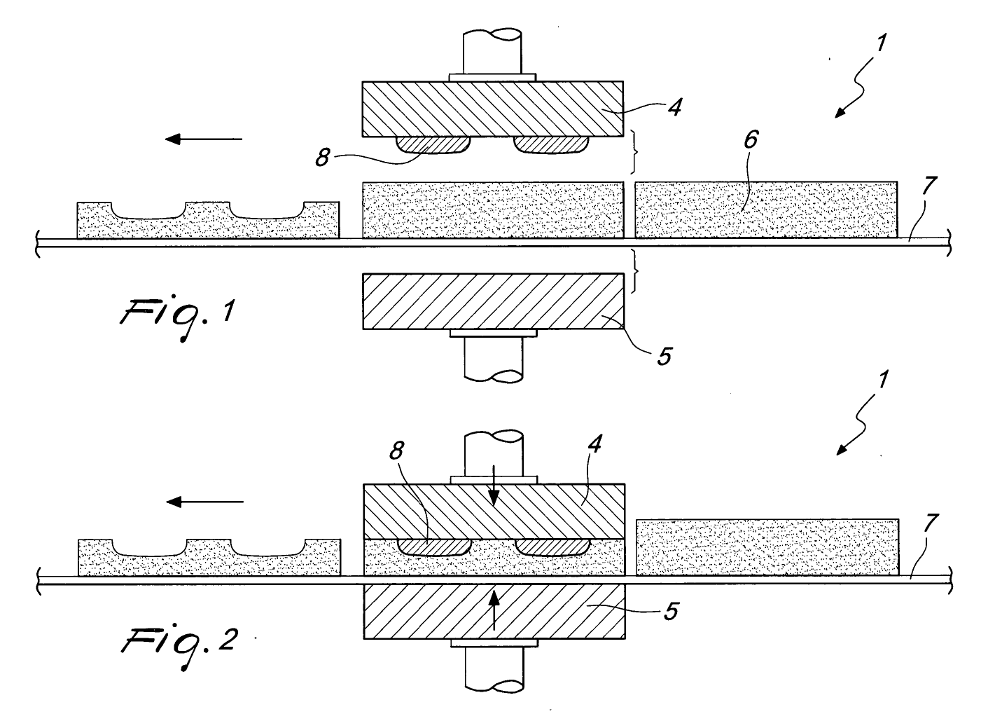

Particularly but not exclusively with reference to a first embodiment of the machine 1, as shown in FIGS. 1 and 2, the loose material 6 can be of the type of intermediate components which have a substantially plate-like shape, are made of pre-pressed material and can be arranged individually between the upper mold part 4 and the lower mold part 5 by way of the feeder line 7 or a loading station.

The upper mold part 4 and the lower mold part 5 are substantially plate-like and can move along a substantially vertical direction of translational motion toward and away from the conveyor belt 7 in order to press an intermediate component made of loose material 6.

The machine 1 further comprises two appropriately shaped (for example rounded) shaping elements 8, which protrude from the lower surface of the upper mold part 4 and are detachably associated therewith by way of temporary fixing means such as threaded means (screws or the like).

The shaping elements 8 are mutually spaced and are adapted to shape respective portions of the stringer 2 during the operation for molding by pressing, in order to form two recesses adapted for the insertion of the forks of a lift truck or the like.

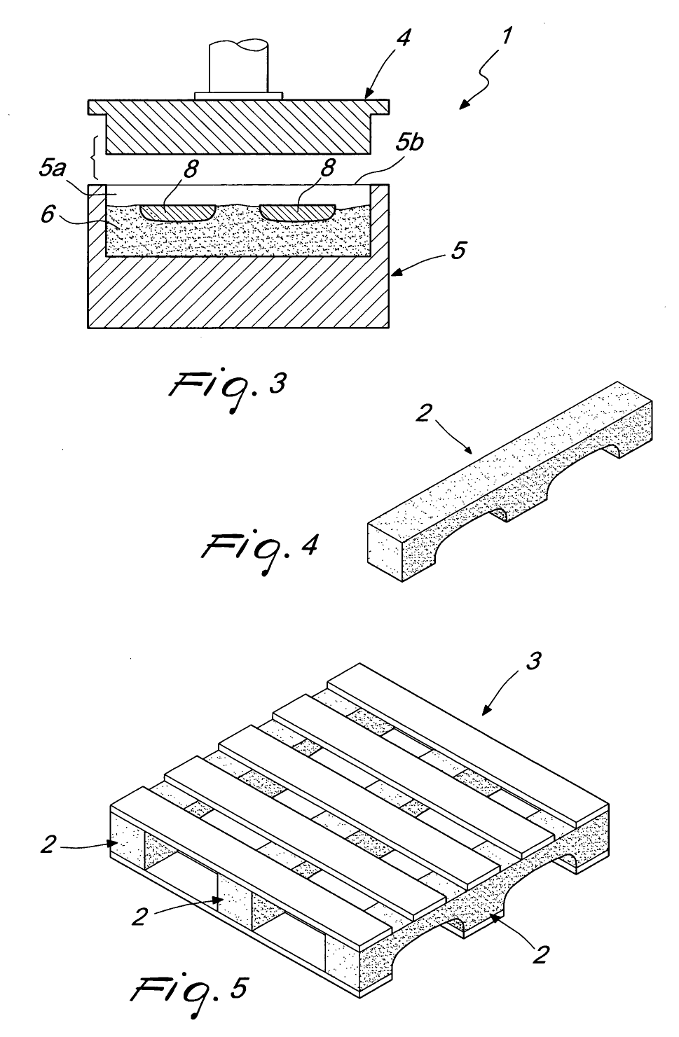

A second embodiment, shown in FIG. 3, provides for the application of a plurality of shaping elements 8 directly at the loose material 6 being moved, before the pressing step.

The shaping elements 8 are immersed partially or completely in a layer of loose material. After moving a portion of such layer at the lower mold part 5, and after the step for molding the portion by way of the pressing action of the upper mold part 4, the shaping elements 8 are removed from the resulting intermediate component in order to form the respective recesses in the stringers.

In particular, as shown in FIG. 3, the lower mold part 5 can comprise a chamber 5a for collecting the loose material 6, which is provided with an upper opening 5b and is arranged below the upper mold part 4.

The upper mold part 4 can move along a substantially vertical direction of translational motion in order to open and close the collection chamber 5a.

Alternative embodiments are also possible in which the shaping elements 8 are associated with the lower mold part 5 and protrude from the bottom of the chamber 5 toward the upper mold part 4, or in which they protrude from the lower surface of the upper mold part 4 toward the chamber 5a.

Advantageously, the shaping elements 8 can have a shape which is substantially elongated along an axis which is substantially parallel to the plane formed by the upper mold part 4, so as to form, after the pressing step, substantially plate-like intermediate components which have respective recesses and from which it is possible to obtain a plurality of stringers 2 by way of subsequent cutting steps.

Conveniently, the machine 1 comprises means for injecting a first hot fluid, such as steam, into the stream of loose material, such means comprising a plurality of steam dispensing ports formed at the outer surface of the shaping elements 8, of the upper mold part 4 or of the lower mold part 5.

Steam injection channels, which end in the dispensing ports, extend from channels for feeding such steam.

The injection means described above are not shown in the figures, since they are of a conventionally used type.

The steam is injected into the mass of loose material 6 before and during the pressing step, in order to act on such material and on any binders so as to obtain quickly a single compact and strong part which forms the stringer 2.

The machine 1 further comprises suction means, which are adapted to produce a vacuum within the collection chamber 7 in order to recover the steam generated during the pressing operation. In a manner similar to what has been described above for the injection means, the suction means can be constituted by appropriate channels formed at the shaping elements 8, on the lower surface of the upper mold part 4 or also on the lower mold part 5.

Conveniently, the machine 1 comprises means for heating the upper mold part 4, the lower mold part 5 and the shaping elements 8. The heating means are not shown in said figures, since they are of a type which is used conventionally.

In a manner similar to what has been described above with reference to the injection means, the heating means are adapted to facilitate the setting of the pressed loose material 6 and optionally the activation of the binders.

In practice it has been found that the described invention achieves the proposed aim and objects.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Patent Application No. MO2005A000290 from which this application claims priority are incorporated herein by reference.

What is claimed is:

1. A machine for molding articles made of loose material, for manufacturing stringers for loading pallets, comprising: an upper mold part; a lower mold part, said upper and lower mold parts being movable mutually closer for being mutually superimposed with interposition of at least one layer of loose material for molding at least one article; and at least one shaping element for shaping at least one portion of the article during molding, said at least one shaping element being suitable to be associated detachably with at least one among said upper mold part, said lower mold part and said layer of loose material.

2. The machine of claim 1, comprising fixing means for temporarily fixing said shaping element to said upper mold part, said lower mold part, or to both.

3. The machine of claim 2, wherein said temporary fixing means are threaded means.

4. The machine of claim 1, comprising a feeder line for feeding said loose material, said upper mold part and said lower mold part being arranged respectively above and below said feeder line.

5. The machine of claim 4, wherein said upper mold part and said lower mold part can move along a substantially vertical direction of translational motion, moving simultaneously toward and away from said feeder line, for pressing said loose material.

6. The machine of claim 5, wherein said shaping element is arranged on said upper mold part.

7. The machine of claim 6, wherein said shaping element is detachably associated at a lower surface of said upper mold part and protrudes toward said lower mold part.

8. The machine of claim 4, wherein said feeder line is a conveyor belt.

9. The machine of claim 1, wherein said lower mold part comprises a collection chamber for collecting said loose material, which is open upward and faces said upper mold part, said upper mold part being movable along a substantially vertical direction of translational motion in order to open and close said collection chamber.

10. The machine of claim 9, wherein said shaping element is arranged so as to protrude from a bottom of said collection chamber toward said upper mold part.

11. The machine of claim 9, wherein said shaping element protrudes from a lower surface of said upper mold part toward said collection chamber.

12. The machine of claim 1, comprising two of said shaping elements, which are arranged mutually spaced.

13. The machine of claim 1, comprising a plurality of said shaping elements.

14. The machine of claim 1, comprising injection means for injecting a first hot fluid into said layer of loose material during molding.

15. The machine of claim 14, wherein said injection means comprise at least one port for dispensing said first hot fluid, said port being formed at at least one among said upper mold part, said lower mold part and said at least one shaping element.

16. The machine of claim 15, wherein said injection means further comprise at least one duct for feeding said first hot fluid.

17. The machine of claim 14, comprising aspiration means for aspirating said first hot fluid.

18. The machine of claim 1, comprising heating means for heating at least one among said upper mold part, said lower mold part and said at least one shaping element.

19. The machine of claim 18, wherein said heating means comprise at least one hydraulic circuit, which is adapted to be crossed by at least one second hot fluid.
